(19) United States
(12) Patent Application Publication
(10) Pub. No.: US 2018/0141065 A1
(43) Pub. Date: May 24, 2018

(54) SPRAYING APPARATUS

(71) Applicant: DARIN CO., LTD., Gyeongsangnam-do (KR)

(72) Inventor: Dae Sik Son, Gyeongsangnam-do (KR)

(73) Assignee: DARIN CO., LTD., Gyeongsangnam-do (KR)

(21) Appl. No.: 15/399,336

(22) Filed: Jan. 5, 2017

(30) Foreign Application Priority Data
Nov. 22, 2016 (KR) 10-2016-0156033

(51) Int. Cl. B05B 11/00

(52) U.S. Cl. CPC B05B 11/0059; B05B 11/3011; B65D 83/32; B05B 11/3045; B05B 11/001; B05B 11/3074

(57) ABSTRACT

Disclosed is a spraying apparatus. The disclosed spraying apparatus includes a housing having a flow path from an inlet to an outlet, through which content passes, a pump provided in the housing and configured to extract content from a container for replenishment or discharging the content, a valve provided in the flow path and configured to selectively shield the flow path, in conjunction with movement of the pump, and an inverted extractor provided in the flow path and configured to extract the content from the container, in conjunction with movement of the pump in an inverted state.

### CROSS-REFERENCE TO RELATED APPLICATION

This application claims priority to and the benefit of Korean Patent Application No. 10-2016-0156033, filed on Nov. 22, 2016, the disclosure of which is incorporated herein by reference in its entirety.

### BACKGROUND

### 1. Field of the Invention

The present invention relates to a spraying apparatus, and more particularly, to a spraying apparatus capable of inverted spraying and having improved assemblability due to a snap-on method.

### 2. Discussion of Related Art

Generally, a sprayer pumps and sprays content (a solution) stored in a container, and a spraying apparatus is provided at an upper portion of the container for this purpose. That is, a sprayer in the related art includes a container which stores liquid-type or paste-type cosmetics or other contents, a cap detachably coupled to the container's neck, and a trigger-type spraying apparatus which is provided at an upper portion of the cap and pumps and sprays a predetermined amount of the liquid-type content by movement of a trigger.

Such a trigger-type spraying apparatus is provided at the upper portion of the cap and includes a main body having a spray nozzle provided at a front end thereof, a pumping mechanism which is provided in the main body and includes a plunger for sucking and pumping content of the container, a trigger coupled to the front end of the main body with a hinge for repeatedly operating the plunger of the pumping mechanism, and a return spring for returning the trigger. A suction tube is coupled to an inlet of the pumping mechanism and extends to a bottom portion of the container.

Therefore, when a user repeatedly pulls the trigger, the content in the container is sucked into the pumping mechanism through the suction tube and then is subsequently sprayed in a spray form through the spray nozzle.

As related art, there is Korea Unexamined Patent Application Publication No. 2010-0128650 (Published on Dec. 8, 2010, Title: EASY-TO-USE SPRAYER).

### SUMMARY OF THE INVENTION

The present invention is directed to a spraying apparatus capable of inverted spraying.

The present invention is directed to a spraying apparatus in which an inlet path and a discharge path are blocked by a single valve, thereby reducing the number of parts, each of the parts is assembled by a snap-on method, and assemblability is improved.

Also, the present invention is directed to a spraying apparatus in which a cover is easily replaced, thereby allowing implementation of various designs.

According to an aspect of the present invention, there is provided a spraying apparatus including a housing having a flow path from an inlet to an outlet, through which content passes, a pump provided in the housing and configured to extract content from a container for replenishment or discharging the content, a valve provided in the flow path and configured to selectively shield the flow path, in conjunction with movement of the pump, and an inverted extractor provided in the flow path and configured to extract the content from the container, in conjunction with movement of the pump in an inverted state.

Also, the housing may include a cover assembled by a snap-on method.

Also, a mounting unit in which the valve is assembled may be opened in the housing when the cover becomes separated.

Also, the housing and the cover may be detachably assembled by a coupling unit, and the coupling unit may include a coupling protrusion formed on the housing, a coupling rail formed on the cover to be slidably coupled to the coupling protrusion, and a coupling and fixing unit configured to maintain a coupled state of the housing and the cover.

Also, the pump may include a pump housing formed in the housing as a predetermined space, into which the content of the container is introduced, and having a pump inlet and outlet which discharges content filled therein, a plunger slidably provided in the pump housing, and a trigger movably provided in the housing, elastically supported by a restoration member from the housing, and configured to slide the plunger.

Also, the valve may include a body coupled to the flow path, a first valve provided in the body and configured to open and close the inlet in conjunction with movement of the trigger, and a second valve provided in the body and configured to open and close the outlet in conjunction with movement of the trigger.

Also, the first valve may include an airtight plate configured to open and close the inlet of the housing, and an elastic member configured to elastically support the airtight plate on the body.

Also, the housing and the trigger may be coupled to each other by a hinge, the hinge may include a hinge shaft formed in the housing, and a hinge bracket formed in the trigger to be rotatably coupled to the hinge shaft, one side of the hinge bracket may be open to be detachable from the hinge shaft, and a coupled state of the hinge bracket and the hinge shaft may be maintained by elastic force of the restoration member.

Also, the housing may be coupled to a cap of the container by a one-touch coupling unit, and the one-touch coupling unit may include a coupling flange formed around a lower end of the housing and a tension coupling unit forcibly fitted in the coupling flange.

Also, the outlet of the housing may include a nozzle, and the nozzle may include an injection mesh member configured to form foam on discharged content.

Also, the inverted extractor may include an adapter having a main pipe line coupled to the housing to be in conjunction with the flow path and an inverted pipe line configured to guide content when inverted, and an opening and closing unit configured to open and close the inverted pipe line in conjunction with the pump.

Also, the opening and closing unit may include a ball member provided in the inverted pipe line and configured to selectively open and close the inverted pipe line, and a separation preventing rib formed on the inverted pipe line to prevent the ball member from being separated from the inverted pipe line.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a perspective view of a spraying apparatus according to an exemplary embodiment of the present invention;

FIG. 2 is an exploded perspective view of the spraying apparatus according to the exemplary embodiment of the present invention;

FIG. 3 is a cross-sectional view taken along line A-A of FIG. 1;

FIG. 4 is an enlarged view of portion A of FIG. 3;

FIG. 5 is a view illustrating assembly of a cover of the spraying apparatus according to the exemplary embodiment of the present invention;

FIG. 6 is a view illustrating a state of an operation of discharging content of the spraying apparatus according to the exemplary embodiment of the present invention;

FIG. 7 is a view illustrating a state of an operation of replenishment with content of a pump housing of the spraying apparatus according to the exemplary embodiment of the present invention; and

FIG. 8 is a view illustrating a state of an operation of discharging content of the spraying apparatus according to the exemplary embodiment of the present invention when being inverted.

### DETAILED DESCRIPTION OF EXEMPLARY EMBODIMENTS

Hereinafter, a spraying apparatus according to an exemplary embodiment of the present invention will be described with reference to the accompanying drawings.

In this process, thicknesses of lines, sizes of components, or the like illustrated in the drawings may be exaggerated for clarity and convenience of explanation. Some terms described below are defined by considering functions in the invention and meanings may vary depending on, for example, a user or operator's intention or customs. Therefore, the meanings of terms should be interpreted based on the scope throughout this specification.

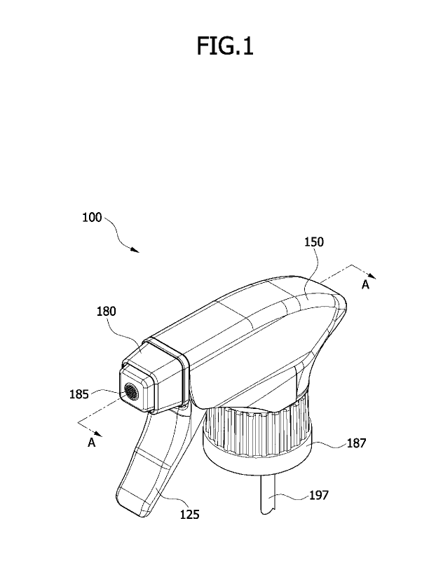

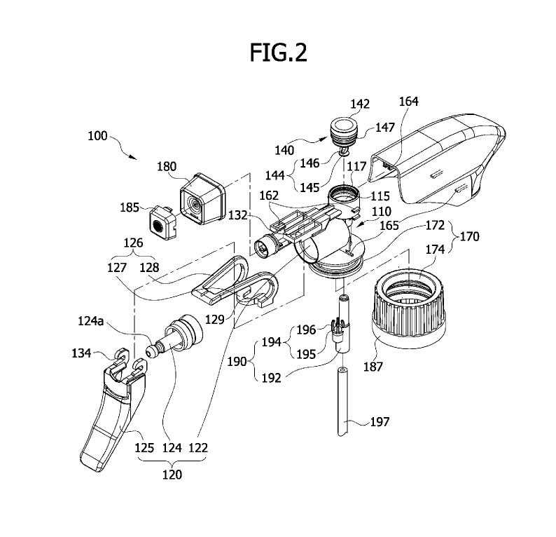

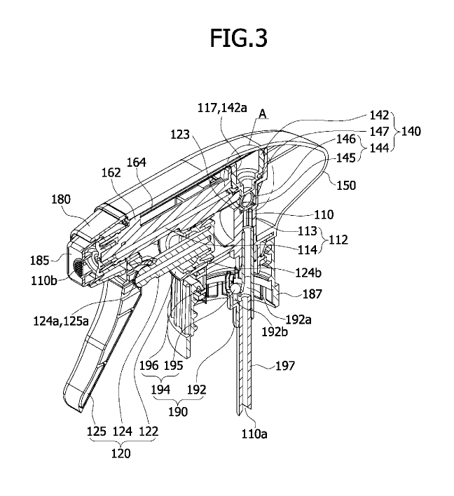

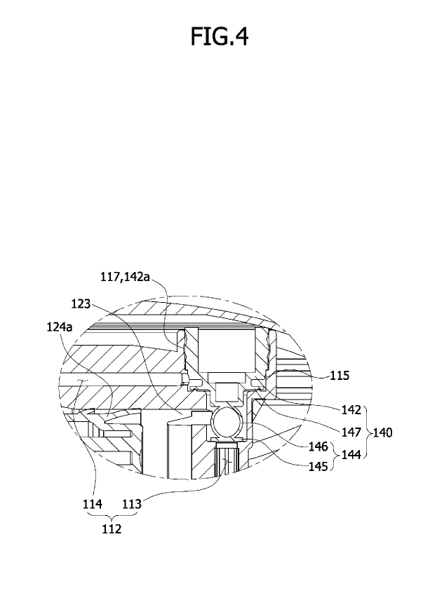

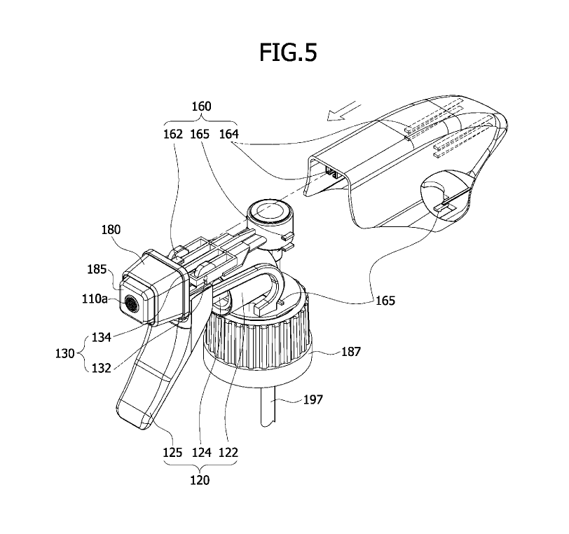

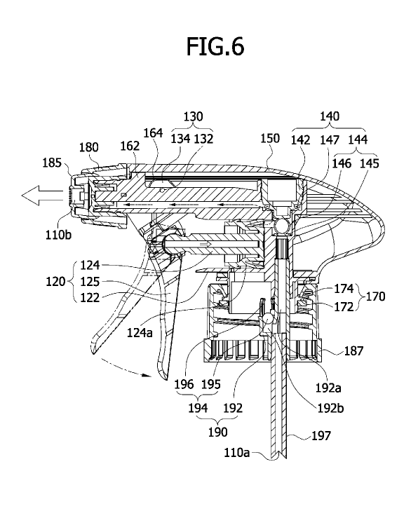

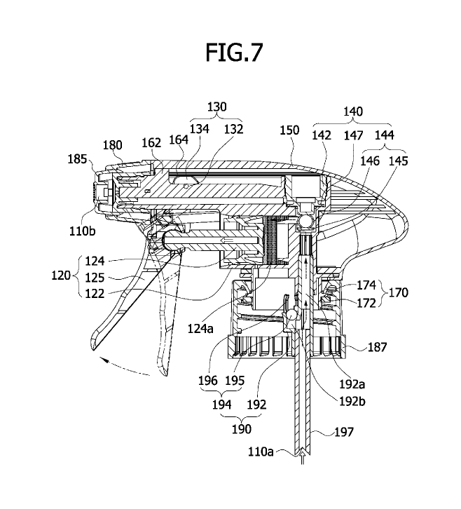

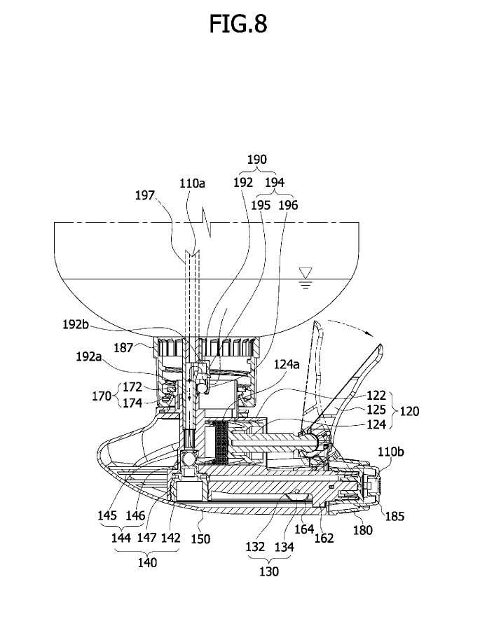

FIG. 1 is a perspective view of a spraying apparatus according to an exemplary embodiment of the present invention, FIG. 2 is an exploded perspective view of the spraying apparatus according to the exemplary embodiment of the present invention, FIG. 3 is a cross-sectional view taken along line A-A of FIG. 1, FIG. 4 is an enlarged view of portion A of FIG. 3, FIG. 5 is a view illustrating assembly of a cover of the spraying apparatus according to the exemplary embodiment of the present invention, FIG. 6 is a view illustrating a state of an operation of discharging content of the spraying apparatus according to the exemplary embodiment of the present invention, FIG. 7 is a view illustrating a state of an operation of replenishment with content of a pump housing of the spraying apparatus according to the exemplary embodiment of the present invention, and FIG. 8 is a view illustrating a state of an operation of discharging content of the spraying apparatus according to the exemplary embodiment of the present invention when being inverted.

Referring to FIGS. 1 to 8, a spraying apparatus 100 according to an exemplary embodiment of the present invention includes a housing 110, a pump 120, a valve 140, and an inverted extractor 190.

The spraying apparatus 100 according to the present invention is an apparatus which is provided on a container and pumps content of the container, and sprays the content in a spray type. The container may have a space formed therein to store content and may be made of various materials such as a synthetic resin and the like.

The housing 110 has a flow path 112 which is formed so that content passes through an inlet 110a and an outlet 110b. The flow path 112 includes a first flow path 113 which extends to the inlet 110a and a second flow path 114 which extends to the outlet 110b. That is, as illustrated in FIG. 3, the first flow path 113 extends from the inlet 110a in a vertical direction, and the second flow path 114 is bent from the first flow path 113 and extends to the outlet 110b in a horizontal direction.

The pump 120 is provided at the housing 110 and extracts the content of the container for replenishment or discharging the content. Such a pump 120 includes a pump housing 122 formed in the housing 110 as a predetermined space, into which the content of the container is introduced, and having a pump inlet and outlet 123 which discharges content filled therein, a plunger 124 slidably provided in the pump housing 122, and a trigger 125 which is movably provided in the housing 110, elastically supported by a restoration member 126 from the housing 110, and slides the plunger 124. That is, the plunger 124 slides into the pump housing 122 by movement of the trigger 125, and thus the content may fill or be discharged from the pump housing 122.

The restoration member 126 is made of a plastic material and includes support ends 127, which are provided at both ends thereof and respectively supported at the trigger 125 and the housing 110, and an elastic piece 128 which connects the support ends 127. The elastic piece 128 has an S-shaped cross-section which connects the support ends 127, and elastically supports the support ends 127. A torsion preventing groove 129 may be formed in the support ends 127. Such a restoration member 126 contracts when external pressure is applied to the trigger 125 and is restored to its initial position when the external pressure is removed.

The plunger 124 may slide inside the pump housing 122 due to the movement of the trigger 125, the valve 140 to be described below may be operated by the sliding of the plunger 124, and thus the content may fill or be discharged from the pump housing 122. A sealing member 124b made of a synthetic resin is provided at the plunger 124 and is brought into close contact with the inside of the pump housing 122.

Also, a hinge protrusion 124a having a spherical shape is formed at the plunger 124, and a hinge groove 125a is formed at the trigger 125 so that the hinge protrusion 124a is coupled to the corresponding hinge groove 125a. The hinge groove 125a may have a C-shape cross-section which accommodates the hinge protrusion 124a and may be moved in all directions in a state in which the spherical-shaped hinge protrusion 124a is coupled thereto.

The housing 110 and the trigger 125 are coupled to each other by a hinge 130. The hinge 130 includes a hinge shaft 132 formed in the housing 110 and a hinge bracket 134 formed in the trigger 125 to be rotatably coupled to the hinge shaft 132. In this case, one side of the hinge bracket 134 is open to be detachable from the hinge shaft 132, and a coupled state of the hinge bracket 134 and the hinge shaft 132 is maintained by elastic force of the restoration member 126.

The valve 140 may be provided at the flow path 112 and may selectively shield the flow path 112 in conjunction with movement of the pump 120. In this case, a mounting unit 115 on which the valve 140 may be mounted is provided at the flow path 112. That is, as illustrated in FIG. 2, the mounting unit 115 is formed at an upper end of the first flow path 113, and the valve 140 is assembled. Also, a fixing groove 117 may be formed in the mounting unit 115, fixing protrusions 142a coupled to the fixing groove 117 may be formed in the valve 140, and thus the fixing groove 117 and the fixing protrusions 142a may be coupled to each other.

The valve 140 includes a body 142 coupled to the flow path 112, a first valve 144 which is provided in the body 142 and opens and closes the inlet 110a in conjunction with movement of the trigger 125, and a second valve 147 which is provided in the body 142 and opens and closes the outlet 110b in conjunction with movement of the trigger 125. That is, as illustrated in FIG. 4, the first valve 144 is formed at a lower end of the body 142, and the second valve 147 is formed on a circumferential surface of the body 142.

The first valve 144 includes an airtight plate 145 which opens and closes the inlet 110a of the housing 110 and an elastic member 146 which elastically supports the airtight plate 145 on the body 142. The elastic member 146 is formed to have a ring shape, and the airtight plate 145 is formed to have a concave and convex shape corresponding to each other so as to form a large contact area with the inlet 110a. Also, since the airtight plate 145 blocks the inlet 110a in a vertical direction by the elastic member 146 and is disposed in a direction perpendicular to the pump inlet and outlet 123 of the pump housing 122, the airtight plate 145 is also pressed downward when the plunger 124 is pressed, and thus sealing capability is improved. By doing this, the content of the pump housing 122 may be prevented from flowing back to the container.

A cover 150 assembled in a snap-on method is provided at the housing 110.

The cover 150 is coupled to the housing 110 to form an external appearance, and the housing 110 and the cover 150 are detachably assembled by a coupling unit 160. As illustrated in FIG. 5, the coupling unit 160 includes coupling protrusions 162 formed at the housing 110, a coupling rail 164 formed at the cover 150 to be slidably coupled to the coupling protrusions 162, and coupling and fixing units 165 which maintain a coupled state of the housing 110 and the cover 150.

The coupling protrusions 162 are formed on an upper surface and both side surfaces of the housing 110, and the coupling rail 164 is also formed on an upper surface and both side surfaces of an inside of the cover 150 to correspond to the coupling protrusions 162.

The coupling and fixing units 165 are formed as hooks to be coupled to each other. The cover 150 slides from a rear side to a front side of the housing 110, is coupled to the coupling protrusion 162 by the coupling rail 164, and is fixed by the coupling by the coupling and fixing units 165 formed as hooks.

The housing 110 is coupled to a cap 187 of the container by a one-touch coupling unit 170, and the one-touch coupling unit 170 includes a coupling flange 172 formed around a lower end of the housing 110 and a tension coupling unit 174 forcibly fitted in the coupling flange 172. The tension coupling unit 174 is formed to be inclined downward from an inner surface of the cap 187 and to have a self-elastic structure as illustrated in FIG. 3. Therefore, when the housing 110 is pressed toward the cap 187 in a state in which the coupling flange 172 is in contact with the tension coupling unit 174, the tension coupling unit 174 contracts and the coupling flange 172 is forcibly coupled, and the tension coupling unit 174 is restored and the coupling flange 172 is prevented from being separated.

Also, a nozzle 180 may be provided at the outlet 110b of the housing 110, and an injection mesh member 185 which forms foam on discharged content may be provided at the nozzle 180.

The inverted extractor 190 is provided at the flow path 112 and extracts the content from the container in conjunction with the movement of the pump 120 in an inverted state. Such an inverted extractor 190 includes an adapter 192 having a main pipe line 192a coupled to the housing 110 to be in conjunction with the flow path 112 and an inverted pipe line 192b which guides content when inverted, and an opening and closing unit 194 which opens and closes the inverted pipe line 192b in conjunction with the pump 120. That is, as illustrated in FIG. 3, the adapter 192 is fitted into and coupled to a lower end of the flow path 112 of the housing 110, and a tube 197 which extends to the container is coupled to a lower end of the main pipe line 192a. Also, the inverted pipe line 192b is formed in the main pipe line 192a to be eccentric, and the inlet 110a is formed at an upper portion thereof.

The opening and closing unit 194 includes a ball member 195 which is provided in the inverted pipe line 192b and selectively opens and closes the inverted pipe line 192b, and a separation preventing rib 196 which is formed at the inverted pipe line 192b to prevent the ball member 195 from being separated from the inverted pipe line 192b.

Hereinafter, action and effect of the spraying apparatus 100 according to the exemplary embodiment of the present invention having such a structure will be described as follows.

First, referring to the assembly of the spraying apparatus 100 according to the present invention, as illustrated in FIG. 2, the trigger 125 is movably coupled to the housing 110 by the hinge 130, and a coupled state of the trigger 125 is maintained by interposing the restoration member 126 between the housing 110 and the trigger 125. In this case, the hinge bracket 134 of the trigger 125 has an open side and thus is easily detached from the housing 110.

Then, the valve 140 is coupled to the mounting unit 115 formed at the first flow path 113 of the housing 110. The fixing protrusions 142a are formed at the peripheral surface of the body 142 of the valve 140, the fixing groove 117 is formed in and coupled to the mounting unit 115, and thus the valve 140 may be prevented from being separated. In the above-described state, the cover 150 is coupled to the housing 110 by the coupling unit 160. Specifically, when the cover 150 slides by matching the coupling protrusion 162 of the housing 110 and the coupling rail 164 of the cover 150, the cover 150 covers an upper portion of the housing 110 and is fixed by coupling the coupling and fixing units 165 formed as hooks.

In this case, since the coupling rail 164 of the cover 150 presses the valve 140 fixed to the mounting unit 115 from an upper side, the valve 140 may be prevented from being separated.

Then, the nozzle 180 including the injection mesh member 185 is coupled to the outlet 110b of the housing 110. Also, a tube 197 is coupled to a lower end of the adapter 192, and the adapter 192 to which the tube 197 is coupled is inserted into and fixed to the flow path 112 at the lower end of the housing 110.

In this way, the assembled housing 110 is coupled to the container by the one-touch coupling unit 170, and the assembly is completed.

As described above, since the housing 110 and the cover 150 are assembled by a snap-on method, assemblability is improved and design is easily changed by replacing the cover 150. Also, the trigger 125 may be easily replaced by the ring-shaped hinge bracket 134 when the trigger 125 is damaged.

When the trigger 125 is pulled after gripping the housing 110 in order for a user to extract the content of the container to the outside, the plunger 124 is moved to the inside of the pump housing 122 while the restoration member 126 contracts as illustrated in FIG. 6, and the plunger 124 presses the content with which the pump housing 122 is filled.

In this case, the second valve 147 is opened by discharge pressure and the content is sprayed into the outlet 110b through the second flow path 114. The nozzle 180 may be provided at the outlet 110b, the injection mesh member 185 may be provided at the nozzle 180, and thus the discharged content may be sprayed in a form of foam.

Then, when the pressure applied to the trigger 125 is released, the trigger 125 is restored to its initial position by elastic force of the restoration member 126, and thus an operation of filling the pump housing 122 with the content is performed. Specifically, as illustrated in FIG. 7, the plunger 124 coupled to the trigger 125 is retracted from the pump housing 122 by the restoration of the trigger 125, vacuum pressure is generated in the pump housing 122 by the retraction of the plunger 124, and the pump housing 122 is filled with the content of the container through the pump inlet and outlet 123 by the vacuum pressure.

The vacuum pressure of the pump housing 122 may lift the first valve 144 to open the inlet 110a, and thus the pump housing 122 may be filled with the content. Also, since the vacuum pressure of the pump housing 122 pulls the second valve 147, and the second valve 147 is prevented from being opened. When the vacuum pressure is removed from the pump housing 122, the airtight plate 145 is brought in close contact with the inlet 110a by elastic force of the elastic member 146 to cover the inlet 110a.

Since the above-described first and second valves 144 and 147 are integrally formed in the body 142, the number of parts may be reduced, and the body 142 may be simply assembled, thereby improving assemblability.

Meanwhile, as illustrated in FIG. 8, the spraying apparatus 100 according to the present invention may spray even in an inverted state.

More specifically, when the container is turned upside down, the content is moved to an upper side of the container, and the tube 197 is not immersed in the content. In this case, the inverted pipe line 192b having an inlet formed at an upper portion thereof is immersed in the content. Also, the inverted pipe line 192b may be opened by lowering the ball member 195 which blocks the inverted pipe line 192b by self-weight thereof, and the content may be extracted through the inverted pipe line 192b when the pump 120 is pumped.

When the spraying apparatus 100 is restored to its original state, the inlet of the tube 197 is immersed in the content, the inverted pipe line 192b is blocked by a self-weight of the ball member 194, and the content may be extracted through the tube 197 when the pump 120 is pumped.

As described above, the spraying apparatus according to the exemplary embodiment of the present invention may spray even in an inverted state, due to the adapter coupled to the housing. Also, the pump housing and the housing in which the flow path is formed are integrated into a single injection product, the content of the pump may be filled and discharged by a single valve, the number of parts may be minimized, the spraying apparatus may be manufactured at low cost, various designs may be implemented because the housing and the cover are detachable, and assemblability may be improved.

The spraying apparatus according to the present invention can spray even in an inverted state, fir to an adapter coupled to a housing.

Also, in the present invention, a pump housing and a housing in which a flow path is formed are integrated into a single injection product, content of a pump may replenish and be discharged by a single valve, the number of parts may be minimized, and thus the spraying apparatus can be manufactured at low cost.

Also, in the present invention, since a housing and a cover are detachable by a coupling unit, the cover can be easily replaced, thereby allowing implementation of various designs.

Also, in the present invention, since the housing and the cover are assembled by the coupling unit in a snap-on method, assemblability can be improved, a valve can be prevented from flowing by coupling the cover, thereby improving operation reliability, the valve can be easily opened, and maintenance can be easily performed.

Also, in the present invention, due to a structural characteristic of a detachable trigger, only a corresponding part needs to be replaced when the trigger is damaged, and thus economical effect can be obtained.

While the invention has been described with reference to exemplary embodiments illustrated in accompanying drawings, these should be considered in a descriptive sense only, and it will be understood by those skilled in the art that various alterations and equivalent other embodiment may be made.

Therefore, the scope of the invention is defined by the appended claims.

What is claimed:

1. A spraying apparatus comprising:
a housing having a flow path from an inlet to an outlet, through which content passes;
a pump provided in the housing and configured to extract content from a container for replenishment or discharging the content;
a valve provided in the flow path and configured to selectively shield the flow path, in conjunction with movement of the pump; and
an inverted extractor provided in the flow path and configured to extract the content from the container, in conjunction with movement of the pump in an inverted state.

2. The spraying apparatus of claim 1, wherein the housing includes a cover assembled by a snap-on method.

3. The spraying apparatus of claim 2, wherein a mounting unit in which the valve is assembled is opened in the housing when the cover becomes separated.

4. The spraying apparatus of claim 2, wherein:
the housing and the cover are detachably assembled by a coupling unit; and
the coupling unit includes:
a coupling protrusion formed on the housing;
a coupling rail formed on the cover to be slidably coupled to the coupling protrusion; and
a coupling and fixing unit configured to maintain a coupled state of the housing and the cover.

5. The spraying apparatus of claim 1, wherein the pump includes:
a pump housing formed in the housing as a predetermined space, into which the content of the container is introduced, and having a pump inlet and outlet which discharges content filled therein;
a plunger slidably provided in the pump housing; and
a trigger movably provided in the housing, elastically supported by a restoration member from the housing, and configured to slide the plunger.

6. The spraying apparatus of claim 5, wherein the valve includes:
a body coupled to the flow path;
a first valve provided in the body and configured to open and close the inlet in conjunction with movement of the trigger; and
a second valve provided in the body and configured to open and close the outlet in conjunction with movement of the trigger.

7. The spraying apparatus of claim 6, wherein the first valve includes:
an airtight plate configured to open and close the inlet of the housing; and
an elastic member configured to elastically support the airtight plate on the body.

8. The spraying apparatus of claim 5, wherein:
the housing and the trigger are coupled to each other by a hinge;
the hinge includes:
a hinge shaft formed in the housing; and
a hinge bracket formed in the trigger to be rotatably coupled to the hinge shaft;
one side of the hinge bracket is open to be detachable from the hinge shaft; and
a coupled state of the hinge bracket and the hinge shaft is maintained by elastic force of the restoration member.

9. The spraying apparatus of claim 1, wherein:
the housing is coupled to a cap of the container by a one-touch coupling unit; and
the one-touch coupling unit includes:
a coupling flange formed around a lower end of the housing; and
a tension coupling unit forcibly fitted in the coupling flange.

10. The spraying apparatus of claim 1, wherein:
the outlet of the housing includes a nozzle; and
the nozzle includes an injection mesh member configured to form foam on discharged content.

11. The spraying apparatus of claim 1, wherein the inverted extractor includes:
an adapter having a main pipe line coupled to the housing to be in conjunction with the flow path and an inverted pipe line configured to guide content when inverted; and
an opening and closing unit configured to open and close the inverted pipe line in conjunction with the pump.

12. The spraying apparatus of claim 11, wherein the opening and closing unit includes:
a ball member provided in the inverted pipe line and configured to selectively open and close the inverted pipe line; and
a separation preventing rib formed on the inverted pipe line to prevent the ball member from being separated from the inverted pipe line.
